(19) United States
(12) Patent Application Publication
(10) Pub. No.: US 2017/0064209 A1
(43) Pub. Date: Mar. 2, 2017

(54) WEARABLE POINT OF REGARD ZOOM CAMERA

(71) Applicants: David Cohen, Nesher (IL); David Mandelboum, Rakefet (IL); Giora Yahav, Haifa (IL); Shai Mazor, Binyamina (IL); Sagi Katz, Yokneam Ilit (IL)

(72) Inventors: David Cohen, Nesher (IL); David Mandelboum, Rakefet (IL); Giora Yahav, Haifa (IL); Shai Mazor, Binyamina (IL); Sagi Katz, Yokneam Ilit (IL)

(21) Appl. No.: 14/836,490

(22) Filed: Aug. 26, 2015

(51) Int. Cl. H04N 5/232; H04N 5/225; G06K 9/00; G06F 3/01

(52) U.S. Cl. CPC H04N 5/23296; G06F 3/013; H04N 5/2253; G06K 9/0061

(57) ABSTRACT

A wearable apparatus configured to acquire zoom images of a portion of an environment viewed by a user responsive to determining a point of regard of the user.

### BACKGROUND

As the boundaries of technology have expanded to enable realization of more and more of people's desires and fantasies, the drive to record and document aspects of daily life that a person finds interesting and may want to share with others, or record for future contemplation and/or enjoyment, has generated a rich variety of portable and wearable cameras. The cameras are generally operable either automatically or with sufficient rapidity to enable a user to image a fleeting scene in which a person is immersed as a passive observer or active participant.

### SUMMARY

An aspect of an embodiment of the disclosure relates to providing a wearable imaging system that is operable to determine a user's point of regard (POR) in an environment and acquire a zoom image of a portion of the environment that includes the POR. In an embodiment, the system, hereinafter also referred to as a “ZoomEye” system or “ZoomEye”, comprises a gaze tracking system, hereinafter also a “gaze tracker”, and a relatively narrow, “zoom”, field of view (FOV) camera, hereinafter also referred to as a zoom FOV (Z-FOV) camera. The gaze tracker is configured to determine and track direction of the user's gaze and thereby the POR of the user in the user's environment. The Z-FOV camera is mounted to a gimbal system that enables the Z-FOV camera to be oriented in a desired direction. A controller comprised in the ZoomEye, is configured to control the Z-FOV camera to point towards and acquire a zoom image of the POR responsive to the gaze direction provided by the gaze tracker and a suitable input signal generated by the user. In an embodiment, the gaze tracker comprises a camera, hereinafter also referred to as a gaze tracker camera that acquires images of an eye of the user to provide data for determining the user's direction of gaze. Optionally, ZoomEye comprises a wide angle FOV camera, hereinafter also referred to as an “area camera”, that acquires images, “area images”, of the user's environment in a FOV larger than, and that may include, the zoom FOV of the Z-FOV camera.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1 schematically shows a glasses mounted ZoomEye, in accordance with an embodiment of the disclosure;

FIG. 2A and 2B schematically illustrate determining a direction of gaze for an eye responsive to features of the eye imaged by a camera;

FIG. 3 schematically shows a rotary motor gimbal to which a Z-FOV camera may be mounted, in accordance with an embodiment of the disclosure;

FIG. 4 schematically shows a piezoelectric bimorph gimbal to which a Z-FOV camera may be mounted, in accordance with an embodiment of the disclosure; and

FIG. 5 schematically shows a piezoelectric bimorph gimbal to which a Z-FOV camera may be mounted, in accordance with an embodiment of the disclosure.

### DETAILED DESCRIPTION

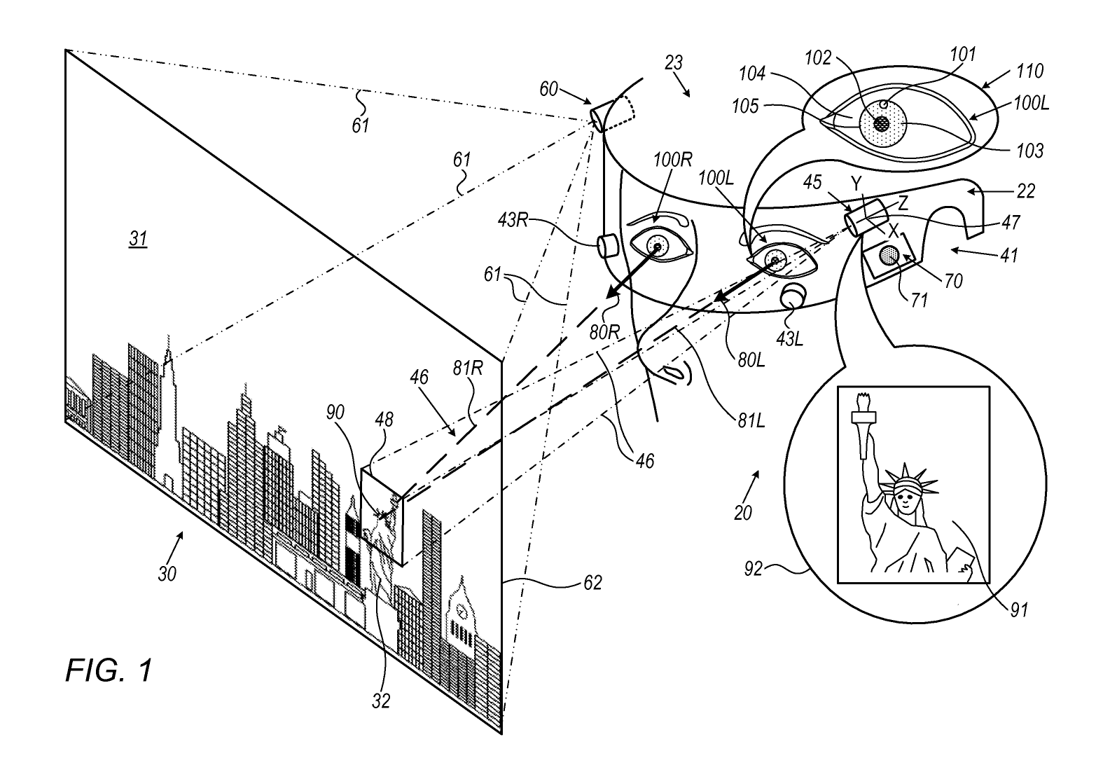

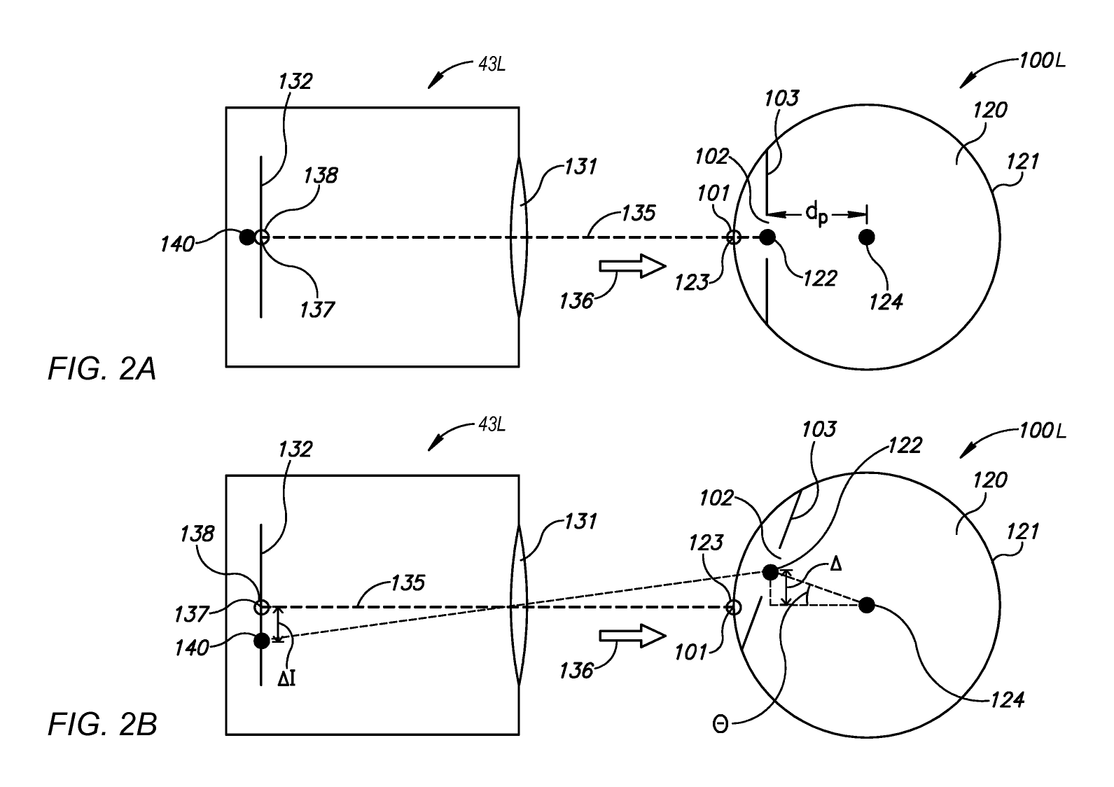

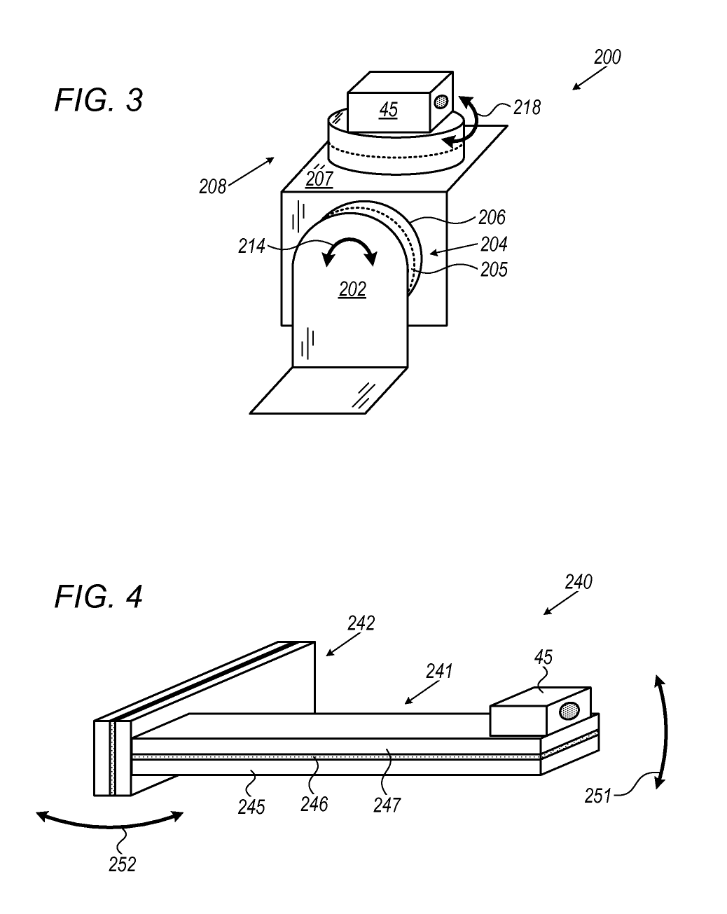

In the detailed description below aspects of a ZoomEye system in accordance with an embodiment of the disclosure are discussed with reference to a head mounted ZoomEye that a user is operating to acquire zoom images of regions of a cityscape. FIG. 1 schematically shows a user wearing a head mounted ZoomEye and using the ZoomEye to acquire zoom images of regions of interest to the user in a city environment in accordance with an embodiment. FIGS. 2A and 2B illustrate features of an optical gaze tracker that identifies features of a user's eye in images of the eye acquired by a gaze tracking camera to determine a gaze direction for the user. FIGS. 3-5 provide examples of gimbal to which a Z-FOV camera may be mounted in accordance with an embodiment of the disclosure.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins

FIG. 1 schematically shows a ZoomEye 20 mounted to a pair of glasses 22 worn by a user 23, in accordance with an embodiment of the disclosure. ZoomEye 20 is shown operating to determine a POR of the user in a scene 30 that the user is viewing and to acquire a zoom image of the POR and a neighborhood of the scene comprising the POR. A zoom image of a POR and its neighborhood imaged by ZoomEye 20 may be referred to as an image of the POR. By way of example in FIG. 1 user 23 is shown viewing a cityscape 31 in which the statue of liberty 32 is visible.

ZoomEye 20 comprises a gaze tracker, optionally an optical gaze tracker 41 having at least one gaze tracker camera that images an eye of the user, and a Z-FOV camera 45, which has a relatively narrow angle FOV 46 and relatively large focal length that enable the Z-FOV camera to acquire relatively “magnified” zoom images of a scene that the camera images. The Z-FOV camera is mounted to a gimbal represented by a Cartesian coordinate system 47 having x, y, and z coordinate axes. A numeral, 46 labels dashed lines which schematically delineate a solid angle that may define the narrow angle FOV of Z-FOV camera 45 and the numeral 46 may be used to reference the FOV of the Z-FOV camera. FOVs and their characterizing solid angles are discussed below. Gimbal 47 is optionally a two axes gimbal which allows Z-FOV camera 45 to be rotated about the x and y axes. An optical axis of Z-FOV camera 45 is coincident with the z-axis of the gimbal. Examples of gimbals to which Z-FOV camera 45 may be mounted are shown in FIGS. 3-5 and discussed below with respect to the figures.

By way of example, ZoomEye 20 comprises two gaze tracker cameras 43L and 43R, which image left and right eyes 100L and 100R respectively of user 23. Gaze tracker cameras 43L and 43R may be referred to generically by the numeral 43, and eyes 100L and 100R generically by the numeral 100. In an embodiment, ZoomEye 20 comprises an area camera 60 having a relatively wide angle FOV 61. A numeral, 61 labels dashed lines which schematically delineate a solid angle that may define the wide angle FOV of area camera 60 and the numeral 61 may be used to reference the FOV of the area camera. A controller 70, is configured to control operation of, and process data provided by components of ZoomEye 20.

The FOV of a camera is a region of space defined by a solid angle that extends from an optical center of the camera and for which points therein are imaged by the camera's optical system on a photosensor that the camera comprises. A view angle of a camera's FOV is a largest possible angle between lines that lie in the camera's FOV and extend from the camera's optical center. A view angle may be defined for any plane that intersects the camera's optical center. View angles are generally defined for planes that contain the camera's optical axis. Practical view angles for imaging human activities are usually horizontal and vertical view angles defined for planes respectively parallel to, and perpendicular to the ground. A narrow angle FOV, such as FOV 46 that Z-FOV camera 45 may have is characterized by a relatively narrow horizontal view angle, and a relatively narrow vertical view angle. A wide angle FOV, such as FOV 61 that area camera 60 may have, is generally characterized by a relatively wide horizontal view angle, and relatively wide vertical view angle.

View angles for the FOV of a camera are determined by a size of the camera photosensor and a focal length of the camera optics. For a camera comprising a photosensor that measures 24 millimeters (mm) by 36 mm, conventionally referred to as a 35 mm format camera, a lens that images scenes on the photosensor having a 50 mm focal length is considered to have a “normal” focal length and the camera may be considered to acquire images having a “normal” magnification. For focal lengths greater than about 35 mm the camera is considered to have a telephoto or zoom focal length and the camera may be considered to acquire magnified images of scenes. For a 35 mm format camera having focal lengths between 50 mm and 100 mm, the horizontal FOV view angle is between about 40° and about 20° assuming that the 36 mm width of the camera photosensor is a horizontal direction of the photosensor. For a focal length of 200 mm, the horizontal view angle is equal to about 10°. For focal lengths shorter than 35 mm, a 35 mm format camera may be considered to be a wide view angle FOV camera. The view angle for a focal length between 35 mm and 20 mm is between about 52° to about 85°. Cameras having same shape but different size photosensors have same view angles if their respective focal lengths scale with the sizes of the photosensors.

A wide angle FOV enables a camera to image a relatively large region of scene. A narrow angle FOV enables a camera to acquire an image of a relatively small region of a scene but at a relatively high resolution. For example a relatively large region, schematically delimited by a rectangle 62, of cityscape 31 viewed by user 23 is located within FOV 61 of area camera 60 and the area camera may be controlled to image a relatively large region of the cityscape in a single image. On the other hand, a relatively small region, schematically delimited by a rectangle 48, of cityscape 31 is located within FOV 46 of Z-FOV, and the Z-FOV images a relatively small region of the scene in a single relatively high resolution image. However, whereas narrow angle FOV 46 may be much smaller than wide angle FOV 61 so that it may be substantially completely contained within the wide angle FOV, in an embodiment, gimbal 47 allows the optical axis of Z-FOV camera 45 to be oriented so that substantially all regions of wide angle FOV 61 of area camera 60 may be overlapped by a portion of narrow angle FOV 46.

In an embodiment, the FOV of Z-FOV camera 45 is fixed. In an embodiment the FOV of Z-FOV camera 45 is adjustable. In an embodiment, a Z-FOV camera such as Z-FOV camera 45 is considered to be a zoom camera if it is configured to image a portion of scene that an area camera, such as area camera 60, is configured to image at a higher image resolution than an image resolution of the area camera.

Controller 70 may comprise any processing and/or control circuitry known in the art to provide the controller's control and data processing functionalities, and may by way of example comprise any one or any combination of more than one of a microprocessor, an application specific circuit (ASIC), field programmable array (FPGA) and/or system on a chip (SOC). Controller 70 may communicate with gaze tracker cameras 43, Z-FOV camera 45, and area camera 60 by any of various suitable wireless or wire communication channels. And whereas controller 70 is schematically shown as a single component, controller 70 may be a distributed controller having components comprised in more than one component of ZoomEye 20.

In an embodiment, during operation, gaze tracker cameras 43 repeatedly acquire images of eyes 100 and transmit the images to controller 70. Controller 70 processes the images to determine a gaze vector for each eye, which extends optionally from the pupil of the eye and points in a direction that the eye is looking. Optionally, controller 70 determines a POR as an intersection of the gaze vectors from the left and right eyes 100L and 100R. In FIG. 1, controller 70 is schematically shown having processed images of left and right eyes 100L and 100R provided by gaze tracker cameras 43 to determine gaze vectors 80L and 80R respectively for left eye 100L and right eye 100R. Left eye 100L is looking along a gaze direction 81L indicated by gaze vector 80L and right eye 100R is looking along a gaze direction 81R indicated by gaze vector 80R. Controller 70 determines a POR 90 for user 23 in cityscape 31 optionally by determining, an intersection point or region of closest approach of gaze directions 81L and 81R. In FIG. 1 controller 70 has determined that POR 90 is located at a portion of the statue of liberty 32 and in response to the determination, controls gimbal 47 to orient Z-FOV camera 45 so that the camera's optical axis (coincident with the z-axis of gimbal 47) substantially intersects POR 90. With the gaze of user 23 directed to POR 90 and Z-FOV camera 45 pointed at the POR, user 23 may provide a suitable user input to ZoomEye 20 so that controller 70 triggers the Z-FOV camera to acquire a zoom image of the POR—namely, by way of example, a zoom image 91 shown in an inset 92 of the statue of liberty.

A user input to ZoomEye 20 in accordance with an embodiment of the disclosure may for example be a tactile input provided by making contact with a touch sensitive pad, an audio input generated by vocalizing a prerecorded word or sound, and/or an optical input, for example by suitably blinking or winking an eye imaged, optionally, by a gaze tracker camera 43. Optionally, an input interface configured to receive user input is comprised in ZoomEye 20. In an embodiment, ZoomEye 20 comprises a wireless communication interface (not shown) which ZoomEye 20 uses to communicate with a mobile communication device such as a smartphone, laptop, or tablet. ZoomEye 20 may receive user input from the mobile communication device that the user provides by operating a user input interface that the mobile communication device comprises.

In an embodiment, ZoomEye 20 is configured to image a user POR if the user maintains his or her gaze on the POR for a dwell time greater than a predetermined dwell time threshold. For example, ZoomEye 20 may acquire a zoom image of POR 90 and thereby the statue of liberty 32 when processing of images acquired by gaze tracker cameras 43 indicates that user 23 has substantially uninterruptedly maintained gaze at POR 90 for a period of time greater than the dwell time threshold. A dwell time threshold may be a period of time greater than, for example 20 s (seconds) and may be user adjustable.

By way of example, controller 70 comprises a touchpad 71, configured to receive user input for ZoomEye 20. User 23 may operate touchpad 71 to cause ZoomEye 20 to trigger area camera 60 to acquire a wide angle image of a scene viewed by user 23 or to trigger Z-FOV camera 45 to acquire a zoom image of the user POR. And in FIG. 1 user 23 is assumed to have appropriately operated touchpad 71 to acquire zoom image 91 of the statue of liberty shown in inset 92.

Whereas in the above examples of user input to ZoomEye 20, the generated input may be a volitional input, a ZoomEye in accordance with an embodiment may be configured to trigger Z-FOV camera to acquire zoom images responsive to unintentional input from a user. For example, in an embodiment Z-FOV camera may comprise a sensor or sensors that generates input signals to controller 70 responsive to unintentional physiological changes, such as changes in blood pressure, heart rate, temperature, skin conductivity, and/or skin color of user 23.

Optionally, ZoomEye 20 comprises a memory (not shown) in which it stores images it has acquired, such as image 91 of the statue of liberty. In an embodiment, ZoomEye 20 uses a wireless communication interface (not shown) that it comprises to establish a communication channel with a memory via which the controller may transmit images it acquires to the memory for storage. The memory may by way of example be comprised in a personal computer, or any mobile communication device such as a smartphone, laptop, or tablet. Optionally the memory is cloud based and controller 70 is configured to operate its wireless communication interface to establish communication with a Bluetooth, WiFi, and/or mobile phone network to establish communication with and transmit images it acquires with the cloud based memory.

To determine a gaze vector for an eye 100 controller 70 processes images that a gaze tracker camera 43 imaging the eye provides, using any of various pattern recognition algorithms to identify and locate an image of an eye in the images and to identify at least one feature of the eye that is useable for determining a direction of a gaze vector associated with the eye. The at least one identified eye feature may for example comprise at least one or any combination of more than one of the pupil, the iris, and/or a boundary, conventionally referred to as the limbus, between the iris and the sclera.

In an embodiment each gaze tracker camera 43 comprises a light source (not shown) that illuminates the eye that the gaze tracker camera images with, optionally, infrared (IR) light to generate IR reflections from the cornea and internal structures of the eye that the gaze tracker camera images. The reflections are known as “Purkinje reflections”, and may be used in accordance with an embodiment of the disclosure to determine a gaze vector for the eye. A Purkinje reflection from the cornea is relatively strong and is conventionally referred to as a glint. An enlarged image of left eye 100L imaged by gaze tracker camera 43L is schematically shown in an inset 110 in FIG. 1. A glint 101 generated by reflection of optionally IR light, a pupil 102, an iris 103, sclera 104, and the limbus 105, are schematically shown for the eye in the inset. FIGS. 2A and 2B illustrate relationships between a glint 101 and features of eye 100L that may be used in an embodiment for determining a gaze vector for eye 100L responsive to images of glint 101 and pupil 102 of the eye.

FIGS. 2A and 2B show a schematic circular cross section 120 of an eye 100, assumed to be a sphere having a surface 121, center of rotation 124, an iris 103, and a pupil 102 having a center 122 located at a distance “dₚ” from center of rotation 124. Whereas the eye is not a perfect sphere, but is slightly ovate with a bulge at the location of the cornea, modeling the eye as a sphere provides qualitative and quantitative insight into aspects of determining gaze direction. Typically, the eye has a diameter equal to about 24 mm and dₚ is equal to about 10 mm. In FIGS. 2A and 2B gaze tracker camera 43L is schematically shown having an optical axis 135, a lens 131, and a photosensor 132, and imaging eye 100.

In FIG. 2A, center of rotation 124 of eye 100 is assumed by way of example to be located along optical axis 135 of gaze tracker camera 43L and the eye is assumed to be illuminated by light, represented by a block arrow 136, that is coaxial with optical axis 135. The light is reflected by surface 121 of eye 100 to generate a glint 101 at an intersection 123 of optical axis 135 and the eye surface. The glint is imaged on photosensor 132 with a center of the glint image located at an intersection 137 of optical axis 135 and the photosensor. A circle 138 at intersection 137 schematically represents the image of glint 101. In the figure, a gaze of eye 100 is assumed to be directed towards gaze tracker camera 43L along optical axis 135. As a result, pupil 102 is aligned with glint 101 and center 122 of the pupil lies on optical axis 135. Pupil 102 is imaged on photosensor 132 with the center of the pupil image located at intersection 137 and coincident with the center of image 138 of glint 101. The image of pupil 102 is schematically represented by a filled circle 140 located to the left of circle 138 representing the image of glint 101.

FIG. 2B schematically shows eye 100 being imaged as in FIG. 2A, but with the eye and its gaze direction rotated “upwards” by an angle θ. As a result, whereas glint 101, because of the substantially spherical curvature of the surface of eye 100 has not moved, pupil 102 is no longer aligned with glint 101 along optical axis 135. Center 122 of pupil 102 is located a distance Δ=dₚ sin θ from optical axis 135 and image 140 of the center of pupil 102 is no longer located at intersection 137 and coincident with the center of glint 101.

If magnification of gaze tracker camera 43L is represented by “M”, centers of images 138 and 140 of glint 101 and pupil 102 are separated by a distance Δ_{I}=MΔ=Mdₚ sin θ. Gaze direction θ of eye 100 can be determined from a relationship sin θ=(Δ_{I}/Mdₚ). In practice, images of a pupil and a glint are generally not perfect circles, and typically Δ_{I} is determined as a distance between centroids of images of the pupil and glint.

Gimbal 47 may be any of various gimbals that enable Z-FOV camera 45 to be oriented in different direction in accordance with an embodiment of the disclosure.

By way of example, FIG. 3 schematically shows a gimbal 200 to which Z-FOV camera 45 may be mounted in accordance with an embodiment of the disclosure. Gimbal 200 optionally comprises a mounting bracket 202 to which a micromotor 204 is mounted. Micromotor 204 is optionally a rotary micromotor having a stator 205 mounted to mounting bracket 202 and a rotor 206 coupled to an “L” bracket 207 to which a second rotary micromotor 208 is mounted. Z-FOV camera 45 is mounted to the L bracket. Micromotors 204 and 208 are operable to provide rotations in directions indicated by curled arrows 214 and 218 respectively to point Z-FOV camera 45 in a desired direction.

FIG. 4 schematically shows a piezoelectric crossed bimorph gimbal 240 to which Z-FOV camera 45 may be mounted as shown in accordance with an embodiment in the figure. Piezoelectric bimorph gimbal 240 comprises a first piezoelectric bimorph 241 coupled to a second piezoelectric bimorph 242 so that the planes of the bimorphs are substantially perpendicular to each other. Each piezoelectric bimorph 241 and 242 comprises two layers 245 and 247 of a piezoelectric material such as PZT (lead zirconate titanate) and a common electrode 246 sandwiched between the piezoelectric layers. Each piezoelectric layer 245 and 247 of a piezoelectric bimorph 241 and 242 is covered by an outer electrode (not shown). A controller, for example, controller 70 comprised in the ZoomEye 20 is configured to electrify the electrodes to cause each piezoelectric bimorph 241 and 242 to bend through desired bending angles selectively in each of opposite directions perpendicular to the plane of the piezoelectric bimorph. Bending directions for piezoelectric bimorphs 241 and 242 are indicted by curled arrows 251 and 252 respectively. Controller 70 controls the bending directions and amplitudes of bending angles of bimorphs 241 and 242 to point Z-FOV camera 45 in desired directions.

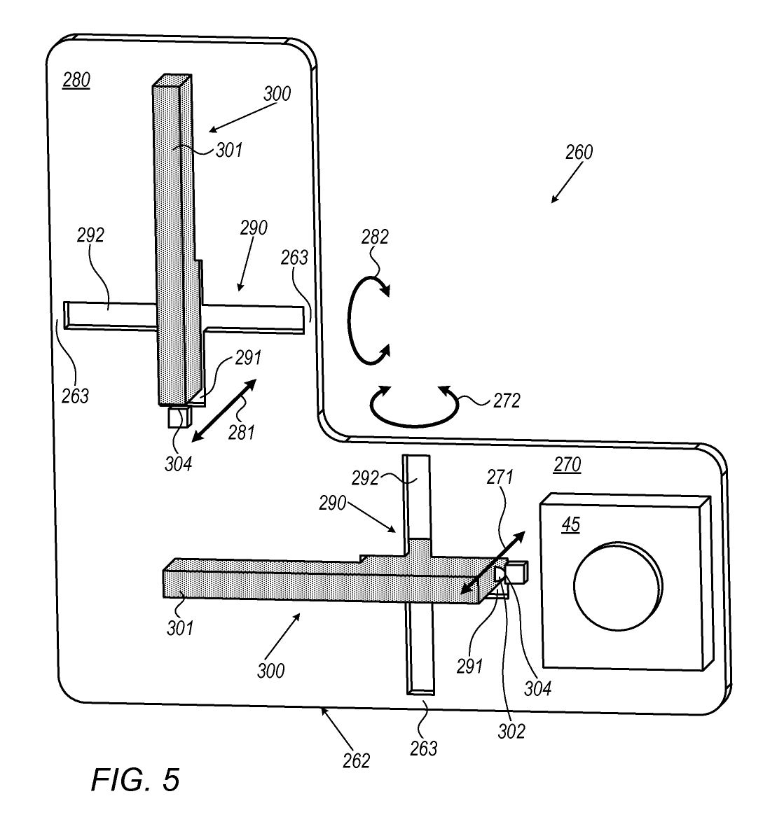

FIG. 5 schematically shows a piezoelectric friction coupled gimbal 260 to which Z-FOV camera 45 may be mounted. Gimbal 260 optionally comprises a substrate 262, which may by way of example be a printed circuit board (PCB), comprising two orthogonal, optionally identical arms 270 and 280, each arm having formed therein an, optionally, “compound” slot 290. The compound slot in each arm 270 and 280 may comprise a longitudinal slot 291 that extends along the length of the arm and a transverse slot 292 that extends across the width of the arm leaving relatively narrow necks 263 on either side of compound slot 290 that act as hinges at which the arm may relatively easily bend. A vibratory piezoelectric motor 300 comprising a rectangular piezoelectric crystal 301 and a friction nub 302 (not shown in arm 280) is mounted in longitudinal slot 290 of each arm 270 and 280 so that the friction nub is resiliently pressed to a friction surface 304 formed on the substrate. A controller, for example, controller 70 comprised in the ZoomEye 20 controls vibratory motion of piezoelectric motor 300 in each arm 270 and 280 and thereby of the arm's friction nub 302 to displace friction surface 304 of the arm selectively in either of opposite directions perpendicular to the plane of the arm and cause the arm to bend in in corresponding opposite directions at the arm's “hinges” 263. Double arrows 271 and 281 indicate directions in which piezoelectric motors 300 may be controlled to displace friction surfaces 304 of arms 270 and 280 respectively. Curved arrows 272 and 282 indicate directions of bending of arms 270 and 280 respectively that correspond to displacements indicated by double arrows 271 and 281. Controller 70 controls piezoelectric motors 300 to control the bending directions and amplitudes of arms 270 and 280 to point Z-FOV camera 45 in desired directions.

It is noted that in the above description, gaze vectors for the eyes of user 23 were determined using an optical gaze tracker comprising gaze tracker cameras that acquired images of the user's eyes. However, practice of embodiments of the disclosure is not limited to optical gaze trackers. A gaze tracker for a ZoomEye may comprise a gaze tracker that determines gaze direction responsive to magnetic dipole fields that the eyes generate or responsive to electrical signals generated by muscles that control eye movement.

It is further noted that whereas in the above description a ZoomEye comprises a head mounted Z-FOV camera, a ZoomEye in accordance with an embodiment may comprise a Z-FOV camera that is mounted on an article of clothing, for example a vest or collar. And whereas in the above description a ZoomEye is shown having a single Z-FOV camera, a ZoomEye in accordance with an embodiment may have a plurality of Z-FOV cameras.

There is therefore provided in accordance with an embodiment of the disclosure apparatus for acquiring images of a user's environment, the apparatus comprising: at least one wearable camera having an optical axis and a narrow angle field of view (FOV) configured to acquire a zoom image of a portion of a scene; a gimbal to which the camera is mounted; a wearable gaze tracker operable to determine a gaze vector for at least one eye of the user and use the gaze vector to determine a point of regard (POR) of the user in the environment; and a controller configured to control the gimbal to point the optical axis of the camera towards the POR and operate the camera to acquire a zoom image of the POR. Optionally, the wearable gaze tracker comprises at least one head mounted gaze tracker camera configured to acquire images of the at least one eye of the user.

The controller may be configured to: receive an image of each of the at least one eye acquired by the at least one head mounted gaze tracker camera; identify at least one feature of the eye in the image; and use the image of the at least one feature to determine the gaze vector for the eye. Optionally, the at least one feature comprises at least one of or any combination of more than one of the pupil, the iris, the limbus, the sclera, and/or a Purkinje reflection. Additionally or alternatively, the at least one eye comprises two eyes of the user and the controller determines a gaze vector for each eye. Optionally, the controller determines the POR as an intersection or region of closest approach of directions along which the gaze vectors of the eyes point.

In an embodiment of the disclosure, the at least one head mounted gaze tracker camera comprises two gaze tracker cameras that acquire images of the at least one eye. Optionally each of the two gaze tracker cameras is configured to acquire an image of a different one of the at least one eye.

In an embodiment of the disclosure, the controller is configured to control the narrow angle FOV camera to acquire the zoom image responsive to at least one volitional user input that the user generates. Optionally, the at least one volitional user input comprises at least one of or any combination of more than one of a tactile input, an audio input, and/or an optical input.

In an embodiment of the disclosure, the controller is configured to control the narrow angle FOV camera to acquire the zoom image responsive to at least one unintentional input generated by the user. Optionally, the at least one unintentional input comprises at least one or any combination of more than one of a change in blood pressure, heart rate, skin conductivity, and/or skin color.

In an embodiment of the disclosure, the controller is configured to control the narrow angle FOV camera to acquire the zoom image responsive to determining that a dwell time of the user's gaze at the POR is greater than a threshold dwell time.

In an embodiment of the disclosure, the gimbal comprises a first piezoelectric bimorph to which the narrow angle FOV camera is mounted and a second bimorph to which the first bimorph is coupled so that the bimorphs and their respective planes are substantially orthogonal.

In an embodiment of the disclosure, the gimbal comprises first and second orthogonal arms comprising first and second piezoelectric vibrators respectively friction coupled to the first and second arms and operable to bend the first arm about a first axis and the second arm about a second axis, which second axis is orthogonal to the first axis.

In an embodiment of the disclosure, the at least one narrow angle FOV camera is characterized by a view angle between about 10° and about 40°. In an embodiment of the disclosure, the apparatus comprises at least one wearable wide angle FOV camera. Optionally, the at least one wearable wide angle FOV camera is characterized by a view angle between about 50° and about 85°. Additionally or alternatively, the gimbal is controllable to orient the at least one narrow angle FOV camera so that substantially all regions of the wide angle FOV may be overlapped by a portion of the narrow angle FOV.

There is further provided in accordance with an embodiment of the disclosure a method of acquiring images of a user environment comprising: using a wearable gaze tracker to determine a gaze vector for the user; determining a POR for the user responsive to a gaze vector; and using a narrow angle FOV camera worn by the user to image the POR.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to users of the art. The scope of the invention is limited only by the claims.

1. Apparatus for acquiring images of a user's environment, the apparatus comprising:
at least one wearable camera having an optical axis and a narrow angle field of view (FOV) configured to acquire a zoom image of a portion of a scene;
a gimbal to which the camera is mounted;
a wearable gaze tracker operable to determine a gaze vector for at least one eye of the user and use the gaze vector to determine a point of regard (POR) of the user in the environment; and
a controller configured to control the gimbal to point the optical axis of the camera towards the POR and operate the camera to acquire a zoom image of the POR.

2. The apparatus according to claim 1 wherein the wearable gaze tracker comprises at least one head mounted gaze tracker camera configured to acquire images of the at least one eye of the user.

3. The apparatus according to claim 1 wherein the controller is configured to:
receive an image of each of the at least one eye acquired by the at least one head mounted gaze tracker camera;
identify at least one feature of the eye in the image; and
use the image of the at least one feature to determine the gaze vector for the eye.

4. The apparatus according to claim 3 wherein the at least one feature comprises at least one of or any combination of more than one of the pupil, the iris, the limbus, the sclera, and/or a Purkinje reflection.

5. The apparatus according to claim 3 wherein the at least one eye comprises two eyes of the user and the controller determines a gaze vector for each eye.

6. The apparatus according to claim 4 wherein the controller determines the POR as an intersection or region of closest approach of directions along which the gaze vectors of the eyes point.

7. The apparatus according to claim 2 wherein the at least one head mounted gaze tracker camera comprises two gaze tracker cameras that acquire images of the at least one eye.

8. The apparatus according to claim 6 wherein each of the two gaze tracker cameras is configured to acquire an image of a different one of the eyes.

9. The apparatus according to claim 1 wherein the controller is configured to control the narrow angle FOV camera to acquire the zoom image responsive to at least one volitional user input that the user generates.

10. The apparatus according to claim 9 wherein the at least one volitional user input comprises at least one of or any combination of more than one of a tactile input, an audio input, and/or an optical input.

11. The apparatus according to claim 1 wherein the controller is configured to control the narrow angle FOV camera to acquire the zoom image responsive to at least one unintentional input generated by the user.

12. The apparatus according to claim 11 wherein the at least one unintentional input comprises at least one or any combination of more than one of a change in blood pressure, heart rate, skin conductivity, and/or skin color.

13. The apparatus according to claim 1 wherein the controller is configured to control the narrow angle FOV camera to acquire the zoom image responsive to determining that a dwell time of the user's gaze at the POR is greater than a threshold dwell time.

14. The apparatus according to claim 1 wherein the gimbal comprises a first piezoelectric bimorph to which the narrow angle FOV camera is mounted and a second bimorph to which the first bimorph is coupled so that the bimorphs and their respective planes are substantially orthogonal.

15. The apparatus according to claim 1 wherein the gimbal comprises first and second orthogonal arms comprising first and second piezoelectric vibrators respectively friction coupled to the first and second arms and operable to bend the first arm about a first axis and the second arm about a second axis, which second axis is orthogonal to the first axis.

16. The apparatus according to claim 1 wherein the at least one narrow angle FOV camera is characterized by a view angle between about 10° and about 40°.

17. The apparatus according to claim 1 and comprising at least one wearable wide angle FOV camera.

18. The apparatus according to claim 17 wherein the at least one wearable wide angle FOV camera is characterized by a view angle between about 50° and about 85°.

19. The apparatus according to claim 17 wherein the gimbal is controllable to orient the at least one narrow angle FOV camera so that substantially all regions of the wide angle FOV may be overlapped by a portion of the narrow angle FOV.

20. A method of acquiring images of a user environment comprising:
using a wearable gaze tracker to determine a gaze vector for the user;
determining a POR for the user responsive to a gaze vector; and
using a narrow angle FOV camera worn by the user to image the POR.
